(19) United States
(12) Patent Application Publication
(10) Pub. No.: US 2007/0065260 A1
(43) Pub. Date: Mar. 22, 2007

(54) Trailer tipper backstop and safety hoop

(76) Inventor: Don K. Chapman, Cabot, AR (US)

Correspondence Address: Kyla D. Cummings;SPEED LAW FIRM, Suite 1200, 111 Center Street, Little Rock, AR, 72201, US

(21) Appl. No.: 11/508,727

(22) Filed: Aug. 23, 2006

Related U.S. Application Data
(60) Provisional application No. 60/710,931, filed on Aug. 23, 2005.

(51) Int. Cl. B65F 9/00

(52) U.S. Cl. 414/354

(57) ABSTRACT

A trailer tipper is disclosed having a sub-frame, a deck pivotally secured to a rear portion of the sub-frame, and means for raising the deck relative to the sub-frame. An adjustable backstop assembly is provided in embodiments. In one embodiment, the adjustable backstop includes cushioning members for cushioning an impact of a trailer with the adjustable backstop. In other embodiments, a safety hoop is generally centrally located on the deck to maintain the trailer on the deck.

### CROSS-REFERENCE TO RELATED APPLICATIONS

This application claims benefit of U.S. Provisional Patent Application Ser. No. 60/710,931, filed Aug. 23, 2005, which is herein incorporated by reference in its entirety.

### BACKGROUND OF THE INVENTION

1. Field of the Invention

Embodiments of the present invention generally relate to trailer tippers. Embodiments more particularly relate to portable trailer tippers.

2. Description of the Related Art

Trailer tippers and low profile, portable trailer tippers are known in the art. Examples of a few such tippers are disclosed in U.S. Pat. Nos. 5,458,451 and 6,019,568, each of which is incorporated herein by reference in its entirety. Trailer tippers are also described in U.S. Pat. No. 6,860,695 issued on Mar. 1, 2005 (hereinafter “'695 Patent”), which is also herein incorporated by reference in its entirety. In particular, FIGS. 7-10 of the '695 Patent depict various views of a trailer tipper.

A typical trailer tipper includes a sub-frame and a deck pivotally secured to a rear portion of the sub-frame. Two spaced-apart safety hoops are typically attached to the deck floor, each safety hoop attached ⅓ of the length of the deck from each end of the deck so that the ends of the deck and the closest safety hoop thereto are equidistant and so that the safety hoops are also this same distance from one another. Each safety hoop generally includes a U-shaped steel beam connected at each of its ends to the floor of the deck to prevent a trailer from falling off the side of the deck when the deck is in the lowered position or in the pivotally raised position relative to the sub-frame. The current safety hoop design and placement of the safety hoops on the deck are not ideal for preventing the trailer from falling from the deck and for balancing the load of the trailer. Furthermore, the current two-safety hoop design is not portable or easily transportable and installable on location.

Prior art tippers also typically have adjustable backstops that employ movable backstop members having little or no flexibility. The movable backstop member is typically pivotally connected to the deck so that it swings up or down to accommodate only two different lengths of trailers during the dumping operation. This type of movable backstop member is located in front of the fixed backstop and in the down position allows shorter trailers to be dumped. When dumping a longer trailer, the movable backstop member is rotated upward about a pivot located on one side of the tipper deck. This results in a potentially unsafe condition since the weight of the movable backstop member is suspended over the side of the tipper. In windy conditions, the movable backstop member may also act somewhat like a sail, catching wind and decreasing the stability of the tipper. This type of adjustable backstop also does not provide the flexibility to variably adjust the distance of the movable backstop member from the back of the deck on the fly to accommodate trailers of non-standard lengths or to accommodate trailers with dollies or the like.

A typical trailer is backed up on the deck until its dumping end hits the backstop. When the trailer impacts the backstop, great force is applied to the backstop by the trailer which may result in damage to the trailer, to the contents within the trailer, and/or to the backstop. The typical adjustable backstop does not provide sufficient cushioning to the trailer when the trailer is backed up against the backstop while accommodating different lengths of the trailer and while stabilizing the trailer sufficiently.

The contents of the trailer sometimes become stuck within the trailer even when the trailer is pivoted by the deck to allow the contents of the trailer to fall out of the dumping end of the trailer. Use of external equipment to dislodge the contents of the trailer when the trailer is pivotally suspended by the deck is complicated, dangerous, and costly.

### SUMMARY OF THE INVENTION

It is therefore an object of embodiments of the present invention to provide a trailer tipper that is easy and inexpensive to transport, set up, and reposition.

It is a further object of embodiments of the present invention to provide a tipper of the above type that offers improved stability both during transport and operation.

It is a still further object of embodiments of the present invention to provide a tipper of the above type that offers a safe and flexible adjustable backstop.

It is a still further object of embodiments of the present invention to provide a tipper of the above type that provides an adjustable backstop that may be easily adjusted to accommodate trailers having a wide variety of lengths and accessories.

It is a still further object of embodiments of the present invention to provide a tipper of the above type that reduces the time and labor needed to prepare the tipper for transport and to set up the tipper after transport.

It is a still further object of embodiments of the present invention to provide a tipper of the above type that offers reduced transport costs.

It is yet a further object of embodiments of the present invention to provide an adjustable backstop having sufficient cushioning ability to prevent damage to the backstop, trailer, and/or contents of the trailer.

It is yet a further object of embodiments of the present invention to provide an adjustable backstop having means for dislodging the contents of the trailer thereon or connected thereto.

It is a further object of embodiments of the present invention to provide a safety hoop which effectively stabilizes the load of the trailer and maintains the trailer on the deck, even when the deck is pivoted relative to the sub-frame.

It is yet another object of embodiments of the present invention to provide a safety hoop which is collapsible, portable, and easily transportable to a location.

It is still a further object of embodiments of the present invention to provide a safety hoop which is centralized on the tipper to stabilize the trailer on the deck.

It is a still further object of embodiments of the present invention to provide improved methods for transporting, setting up, and using a trailer tipper.

Toward fulfillment of these and other objects and advantages, the trailer tipper of embodiments has a sub-frame, a deck pivotally secured to a rear portion of the sub-frame, and means for raising the deck relative to the sub-frame. An adjustable backstop assembly is provided in embodiments, the backstop assembly having a first member affixed to the deck and a second member slidably secured to the first member and movable over a path that is substantially parallel to the deck. The backstop assembly may include one or more cushioning members. In other embodiments, at least one central, stable safety hoop is provided on the deck, and the safety hoop may be collapsible, portable, and transportable.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a side elevation view of a tipper in a position ready for use with the deck in a lowered position.

FIG. 2 is a side elevation view of a tipper with a trailer on the deck, and the deck in a raised position.

FIG. 3 is a front view of an adjustable backstop assembly capable of use with the tipper of FIGS. 1-2. The backstop assembly is in the downward position.

FIG. 4 is a front view of the adjustable backstop assembly of FIG. 3 in the upward position.

FIG. 5 is a driver-side view of the adjustable backstop assembly of FIG. 3.

FIG. 6 is a passenger-side view of the adjustable backstop assembly of FIG. 3.

FIG. 7 is a downward view of the adjustable backstop assembly of FIG. 3.

FIG. 8 is a side view of a safety hoop capable of use with the tipper of FIGS. 1-2.

FIG. 9 is a downward view of the safety hoop of FIG. 8.

FIG. 10 shows the safety hoop of FIG. 8 viewed from the end of the deck of the sub-frame towards the backstop.

### DETAILED DESCRIPTION

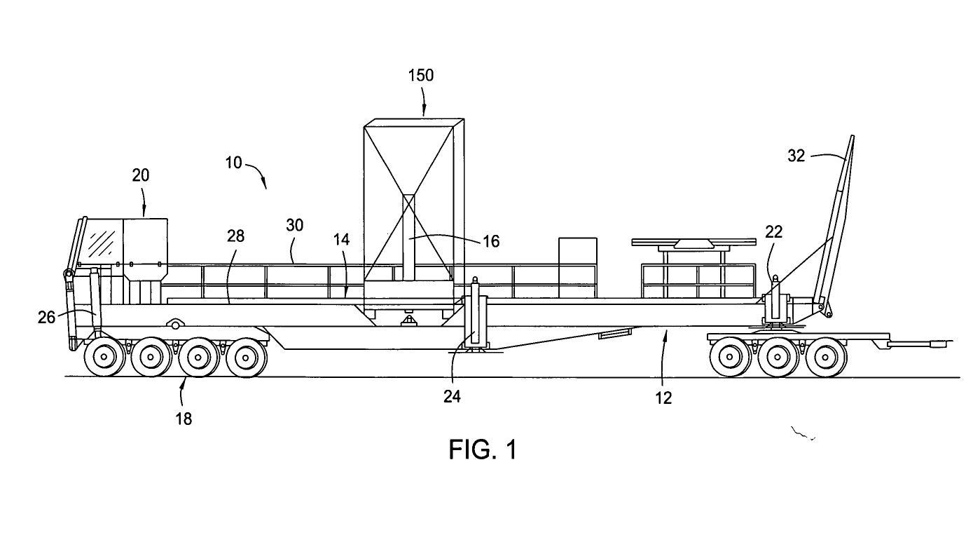

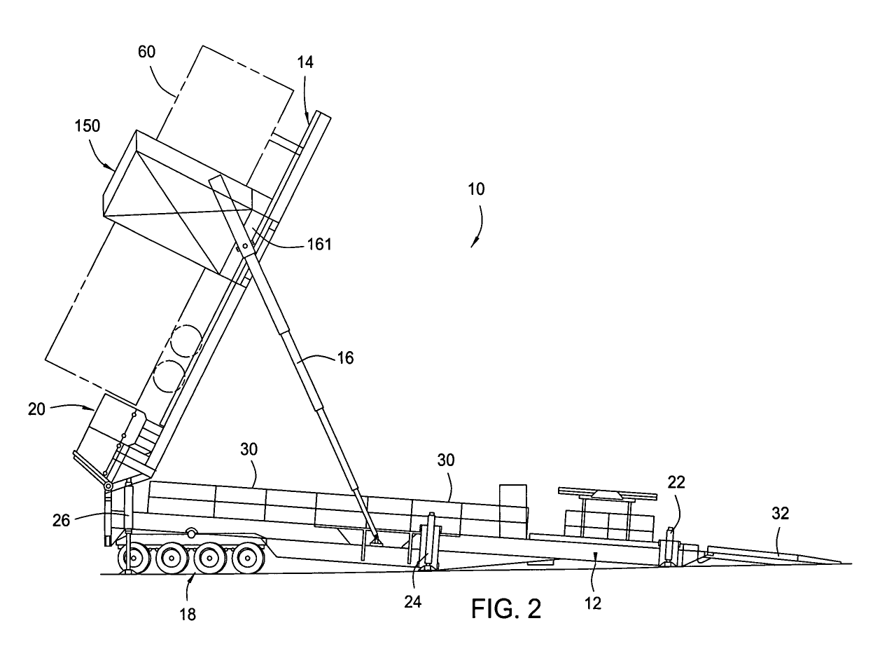

FIGS. 1-2 show a tipper 10 of embodiments of the present invention. The tipper 10 has a sub-frame 12, a deck 14 pivotally secured to a rear portion of the sub-frame 12, and means 16 for raising the deck 14 relative to the sub-frame 12, such as hydraulic cylinders or actuators, or a piston/cylinder assembly. A wheel assembly 18, which may be a pivoting wheel assembly pivotally secured to the sub-frame 12 at its rear portion, is secured to the sub-frame 12 at a rear portion of the sub-frame 12. An adjustable backstop assembly 20 is secured to a rear portion of the deck 14. Front 22, middle or center 24, and rear 26 stabilizers may be optionally affixed to the sub-frame 12. Walkways 28, handrails 30 and/or a ramp 32 may also optionally be affixed to the sub-frame 12.

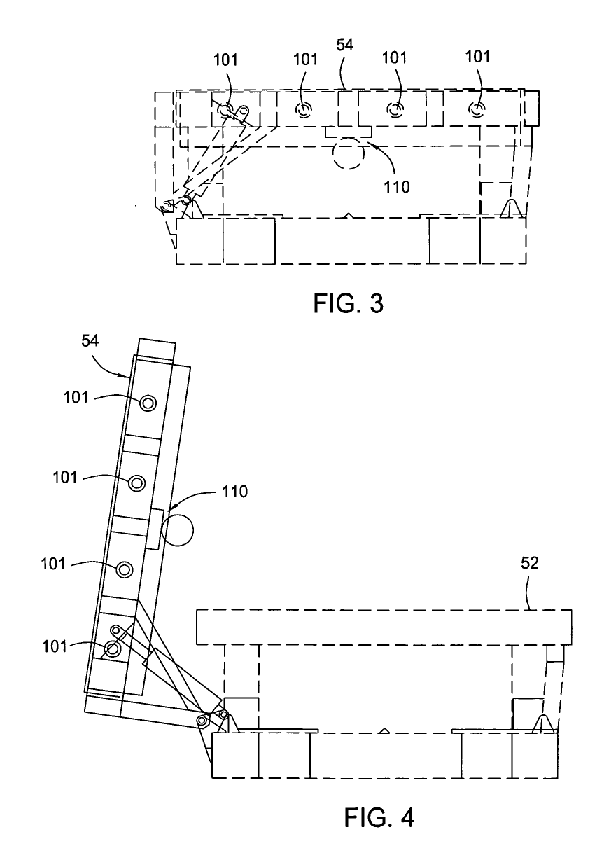

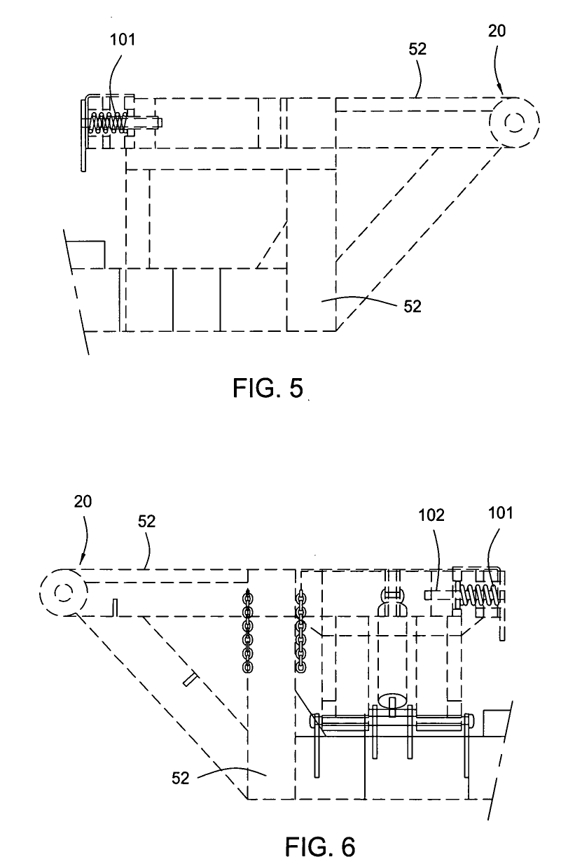

The adjustable, spring-loaded backstop assembly 20 is best seen in FIGS. 3-7. The adjustable backstop assembly 20 may be hydraulic or pneumatically powered and has a first backstop member 52 that is affixed to a rear portion of the deck 14 and a second backstop member 54 that is slidably secured to the first backstop member 52. The adjustable backstop member 54 is telescopically secured to the fixed backstop member 52 so that a substantial portion of the adjustable backstop member 54 is disposed within the fixed backstop member 52 when the adjustable backstop member 54 is disposed in the retracted position as shown in FIG. 5 (also see FIG. 14 of the '695 Patent). Fixed and adjustable backstop members and some other related components are also depicted in FIGS. 14-16 of the '695 Patent. Two hydraulic cylinders 56 are attached to the standard fixed backstop member 52. One end of each hydraulic cylinder 56 is attached to the fixed backstop member 52 and the opposite end of the cylinder 56 is attached to adjustable backstop member 54. Two guides 58, one on each side, are attached to the fixed backstop member 52 to maintain alignment during extension and retraction of adjustable backstop member 54. The hydraulic cylinders 56 move the adjustable backstop member 54 between retracted and extended positions along the guides 58 in a path that is substantially parallel to the upper surface of the deck 14.

When fully retracted, the adjustable backstop member 54 accommodates longer trailer 60 lengths. In order to dump shorter trailers 60, the adjustable backstop member 54 is extended and locked in place. The present design keeps the weight of the adjustable backstop member 54 over the deck 14 and not suspended out past the deck 14 and sub-frame 12 as on prior art tippers, such as the tipper depicted in FIGS. 5-6 of the '695 Patent, resulting in increased safety for the tipper 10 operators and any personnel on the ground 48 in the vicinity of the backstop assembly 20. Another advantage of the adjustable backstop assembly 20 of the present invention is the time-savings to the truck operator and the tipper 10 operator. Since the backstop assembly 20 is adjustable to any number of different extended positions, the backstop assembly 20 can accommodate different trailer 60 lengths, even non-standard trailer 60 lengths, and the truck operator is not required to lower and raise the trailer's dolly. The adjustable backstop assembly 20 may be lengthened or shortened as needed so that the front end of the tipper deck 14 will be positioned to miss the truck's tractor as the deck 14 and trailer 60 are rotated up.

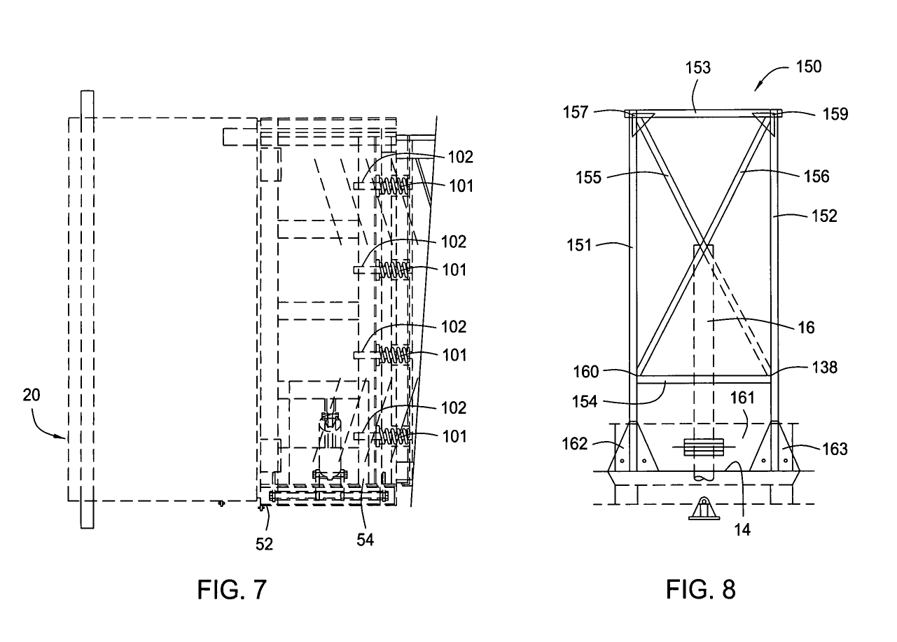

The adjustable backstop assembly 20 may be spring-loaded or biased as best illustrated in FIGS. 5-7. One or more cushioning members or assemblies, such as one or more resilient or biasing members or assemblies, for example one or more spring mechanisms 101, are located on the face of the adjustable backstop assembly 20 so that when a trailer 60 backs into the adjustable backstop assembly 20, the trailer 60 is cushioned by the spring mechanism(s) 101. When multiple spring mechanisms are employed, as in the preferable embodiment shown in FIG. 7, the spring mechanisms 101 are spaced apart across the trailer-abutting face of backstop assembly 20 into which the trailer 60 is backed so that the trailer 60 impacts the spring mechanisms 101 rather than the frame of the backstop assembly 101. Providing multiple spaced-apart spring mechanisms 101 having adequate spring loading provides sufficient impact coverage for the trailer 60 when it is backed into the backstop assembly 20. In one exemplary embodiment shown in FIG. 7, four spring mechanisms 101 are evenly spaced apart across the face of the backstop assembly 20. One or more floating crossbars may be disposed around or adjacent to one or more of the spring mechanisms to provide a surface against which the trailer 60 may impact without directly impacting the spring mechanism(s) themselves, while retaining the cushioning effect of the spring-loading on the backstop/trailer interface.

The spring mechanism(s) are operatively attached to a face of the backstop assembly 20, for example by one or more connecting members such as pin(s) 102. In lieu of or in addition to the spring mechanism(s), other cushioning members may be utilized, such as piston/cylinder assemblies or other biasing or resilient assemblies known to those skilled in the art. The piston/cylinder assemblies may be hydraulically, pneumatically, mechanically, electrically, and/or electro-mechanically powered.

FIGS. 3 and 4 show the backstop assembly 20 front view with the backstop assembly 20 in the downward position (see FIG. 3) and the backstop assembly 20 in the upward position (see FIG. 4). The backstop assembly 20 may optionally include at the underside face of the adjustable backstop member 54 a vibrator mechanism 110 which is capable of vibrating the trailer 60 when it is disposed adjacent to the backstop assembly 20 to shake out difficult-to-remove contents of the trailer 60. The vibrator mechanism 110 may be connected to the underside of the adjustable backstop assembly 20 (for example to the underside of the adjustable backstop member 54) via any connection means known to those skilled in the art, including but not limited to via any connecting members such as bolts, pins, and/or screws. Any vibrator mechanism known to those skilled in the art may be utilized with the adjustable backstop assembly of embodiments of the present invention. The vibrator mechanism 110 is preferably hydraulically-powered, although other methods of powering the vibrating mechanism are contemplated by the inventor. An example of a vibrator mechanism 110 which may be employed in embodiments is the vibrator disclosed in U.S. Pat. No. 4,175,906 issued to Johnson et al. in 1979, which is herein incorporated by reference in its entirety.

FIGS. 1-2 and 8-10 show a safety hoop 150 which operates to maintain the trailer 60 on the deck 14, preventing the trailer from sliding relative to the deck 14 or falling from the deck 14 when the deck 14 is in any position relative to the sub-frame 12 (especially when the deck 14 is pivoted relative to the sub-frame 12 to empty the contents of the trailer 60, as shown in FIG. 2). The safety hoop 150 is more sturdy and stabilizing of the trailer 60 than typically utilized safety hoops due to its frame-like, reinforced structure in lieu of currently utilized one-loop structures.

FIG. 8 shows a view of a side section of the safety hoop 150 disposed on a tipper 10, the view from a side of the tipper 10 (as depicted in FIGS. 1 and 2). Each side of the safety hoop 150 includes at least two generally vertically-disposed beams 151, 152 which are generally parallel to one another and generally perpendicular to the deck 14. The beams 151, 152 are operatively connected to one another via one or more generally horizontally-disposed beams 153, 154 which are generally perpendicular to the beams 151, 152 and which are generally parallel to the deck 14. The beams 151, 152, 153, and 154 cooperate to from a generally rectangular shaped safety hoop 150. This structurally-reinforced safety hoop 150 provides increased support to the trailer 60 when it is disposed within the safety hoop 150 on the deck 14, as the typical safety hoop only includes one beam around the entire trailer 60.

To provide even more structural support to the trailer 60, the side section of the safety hoop 150 may optionally include one or more reinforcing beams 155, 156 or structural braces. These reinforcing beams 155, 156 are generally cross-beams forming an X-shape within the rectangle-shaped structure formed by beams 151-154. The cross-beams 155, 156 are operatively connected to inside-facing surfaces (the inside of the rectangle) of the beams 151, 152, 153, and/or 154. Preferably, an upper end of the cross-beam 155 is operatively connected at or near an intersection point 157 between the beams 151 and 153, and a lower end of the cross-beam 155 is operatively connected at or near an intersection point 158 between the beams 154 and 152. Likewise, preferably, an upper end of cross-beam 156 is operatively connected at or near an intersection point 159 between the beams 152 and 153, and a lower end of the cross-beam 156 is operatively connected at or near an intersection point 160 between the beams 151 and 154.

Although the reinforcing beams 155, 156 are shown and described above as cross-beams forming an X-shape within the rectangle formed from the beams 151-154, the reinforcing beams 155, 156 may instead include any beam design which is capable of reinforcing the side of the safety hoop 150, including but not limited to horizontally-disposed beams connecting beams 153, 154 at additional locations to the ones shown and/or vertically-disposed beams connecting beams 151, 152 at additional locations to the ones shown. In any event, the reinforcing beams 155, 156 act to further brace the beams 151-154, increasing the resistance of the beams 151-154 to bending and/or breaking due to stress placed thereon by the trailer 60 and thereby increasing the stability of the safety hoop 150 and the trailer 60 on the tipper 10.

As seen in FIG. 8, the safety hoop 150 is preferably centered around the means 16 for raising the deck 14 relative to the sub-frame 12 at the position of the means 16 when the deck 14 is not pivoted relative to the sub-frame 12 (the position shown in FIG. 1). The safety hoop 150 (via beams 151, 152) may be operatively mounted/connected to the trailer tipper at trunnion box(es) or other pivotable support(s) 161 for pivotally anchoring the means 16 for raising the deck 14 relative to the sub-frame 12 to the deck 14. Preferably, the safety hoop 150 is operatively attached at one or more locations to the trunnion box or other pivotable support 161 for pivotally anchoring to the deck 14 the means 16 for raising the deck 14 relative to the sub-frame 12. The safety hoop 150 is operatively attached to the pivotable support 161 at lower portions of the beams 151, 152 extending below the beam 154, preferably via one or more connecting members 162, 163 connected to lower portions of the beams 151, 152 and to the side of the pivotable support 161, for example, by one or more screws, nails, and/or bolts.

The safety hoop 150 side section shown in FIG. 8, or a similar side section, is present on both sides of the deck 14 so that the safety hoop 150 is positioned around the top and sides of the trailer 60 when it is disposed in the deck 14. The safety hoop 150 ultimately includes two structures like the one shown in FIG. 8 which are each connected at two points to opposing sides of the pivotable support 161 (a total of four connection points to the pivotable support 161). One side structure of the safety hoop 150 may be operatively connected to a side of the trunnion box(es) at its lower end, while the other side structure of the safety hoop 150 may be operatively connected to an opposite side of the trunnion box(es) at its lower end. The opposing side structures of the safety hoop 150 are not required to be mirror images of one another, and each side structure may be of any configuration in which two generally parallel beams 151, 152 are reinforced and braced to effectively support the trailer 60 on the deck 14.

Of course, instead of being connected to the pivotable support 161, the two side structures of the safety hoop 150 may be connected to other portions of the deck 14. Likewise, the two side structures may be connected to the top of the trunnion box(es) rather than the sides thereof. Regardless of whether the safety hoop 150 is or is not operatively connected to the trunnion box(es), it is preferable that the safety hoop 150 be located at or near a center of the length of the deck 14 to provide maximum control over and maximum stability to the trailer 60 when it is located on the deck 14.

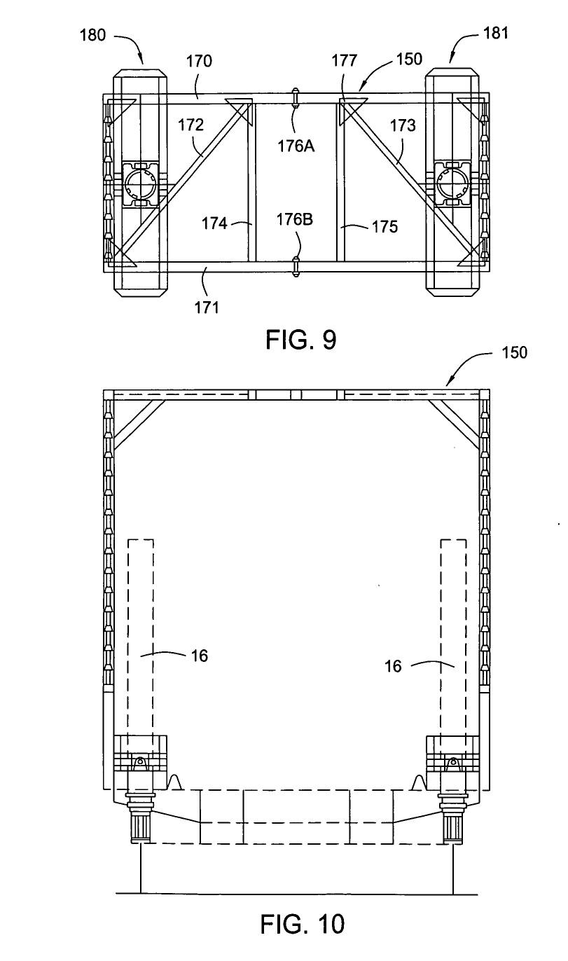

FIG. 9 illustrates a central portion of the safety hoop 150, as viewed from above the deck 14. The central portion of the safety hoop 150 includes at least two generally parallel beams 170, 171 which are operatively connected at their ends to the top of beams 153 located on each side of the safety hoop 150. The beams 170, 171 are generally parallel to one another and generally perpendicular to the beams 151 and 152 of the side portion of the safety hoop 150.

One or more reinforcing beams 172, 173, 174, and 175 may be disposed between the beams 170, 171 to brace and structurally reinforce the safety hoop 150. Although any combination of reinforcing beams is possible and within the scope of embodiments of the present invention, the shown combination is the preferred embodiment. The shown embodiment of reinforcing beams includes two beams 174, 175 which are generally parallel to one another and generally parallel to the beams 153 of the two side structures of the safety hoop 150. These generally parallel beams 174, 175 are preferably spaced apart across the beams 170, 171 approximately the same distance from the beams 153 of the two side structures and from one another. In an embodiment, cross-beam 172 extends cross-wise from the intersection between beams 171 and 153 (one of the side structures) to the intersection between beams 170 and 174 (but may instead extend cross-wise from the intersection between beams 170 and 153 to the intersection between beams 171 and 174). Cross-beam 173 extends cross-wise from the intersection between beams 171 and 153 (the other side structure) to the intersection between beams 170 and 175 (but may instead extend cross-wise from the intersection between beams 175 and 171 to the intersection between beams 170 and 153). Other alternate embodiments include reinforcing beams extending generally parallel (or instead perpendicular) to the beams 170 and 171 from beam 175 to 153 and/or from beam 174 to 153. One or more connection reinforcing members 177 may be connected at the intersection of the beams to reinforce the connections between the beams and increase stability of the safety hoop 150.

As shown in FIG. 9, the safety hoop 150 may optionally include two separate structures 180 and 181 which are ultimately operatively connected to one another at one or more connection points 176A, 176B at the tipping site. The first structure 180 preferably includes one of the side portions and some (preferably approximately ½) of the central portion of the safety hoop 150 shown in FIG. 9; the second structure 181 preferably includes the other side portion and some (preferably approximately ½) of the central portion of the safety hoop 150. (In other embodiments, the safety hoop 150 may be split into more than two structures for future connection to one another, or the safety hoop 150 may be split into two or more structures at different parts of the safety hoop 150. Splitting the safety hoop 150 at the locations shown in FIG. 9, however, is preferable because the two structures 180, 181 are mirror images of one another for ease of construction.) The purpose of the separate structure design is to allow the safety hoop 150 to be transported in two smaller pieces until it is needed at the site of dumping of the trailer 60. When the safety hoop 150 is needed, the two structures 180, 181 are welded and/or bolted to one another at or near connection points 176A, 176B. If it is desired to transport the safety hoop 150 after its assembly by connection of the two structures 180, 181, the bolts may be removed or the welded connection may be cut or otherwise severed to again transport the safety hoop 150 in two pieces for assembly at the next site.

FIG. 10 shows the safety hoop 150 as viewed from an end of the tipper 10 towards the adjustable backstop assembly 20. The means 16 for raising the deck 14 relative to the sub-frame 12 located on each side of the deck 14 are shown, and the safety hoop 150 is shown disposed around these means 16. As is obvious from FIG. 10, the safety hoop 150 is preferably U-shaped to accommodate the shape of the trailer 60 to be disposed therethrough.

The beams used in construction of the safety hoop 150 preferably are constructed of steel tubing (but may be made of any other metal or other material having the ability to support the trailer on the deck 14), which may be of a circular or square cross-section (or of any other shape cross-section). In one embodiment, the beams are expiration steel members. The beams may be solid or contain bores therethrough. The beams are preferably connected to one another at the shown and/or described locations by welding and/or by one or more connecting members such as bolts, screws, and/or nails.

The safety hoop 150 may optionally be heavy duty compared to prior safety hoop designs, meaning that it is wider than currently utilized safety hoops so that the safety hoop is stronger in relation to these prior safety hoops. Optionally, the safety hoop 150 may be supplemented by other safety hoops (not shown) spaced along the length of the deck.

Although any dimensions of the safety hoop 150 are contemplated in embodiments of the present invention, in a preferred embodiment, the outermost diameters of the beams 151 and 152 are disposed approximately 6 feet, 8½ inches apart, and the means 16 is located approximately half-way across this length, so that a central axis of the means 16 is disposed approximately 3 feet, 4¼ inches from each outermost diameter of the beams 151, 152. Also, in a preferred embodiment, the safety hoop 150 possesses a clearance height of approximately 15 feet to accommodate many trailer heights, the height from the lowermost end of the beams 151, 152 to the tops of beams 170, 171 being approximately 15 feet, 4 inches. The preferred embodiment includes a distance between the side sections of the safety hoop (one of them shown in FIG. 8) of approximately 13 feet, 8½ inches, with the connection points 176A, 176B preferably being approximately half of this distance.

An optional pivoting wheel assembly 18 is best seen in FIGS. 11-13 of the '695 Patent. The wheel assembly 18 includes a frame 34, a plurality of axles 36 affixed to the frame 34, and a plurality of wheels 38 rotatably secured to the axles 36. The frame 34 has a lower member formed from rigid elongate members such as longitudinal 40 and transverse I-beams 42. The lower member is affixed to the sub-frame 12 by a single pivot shaft 44 that rotates in two fixed bearings 46 that are attached to the sub-frame 12, allowing the wheel assembly 18 to rotate and move independently of the sub-frame 12. Upper surfaces of the wheels 38 are disposed below lower surfaces of the sub-frame 12. Outer side surfaces of the wheels 38 are substantially aligned with outer side surfaces of the sub-frame 12.

This optional pivoting wheel assembly 18 pivots as a unit relative to the sub-frame 12 in such a manner as to maintain contact of all the wheels 38 with the ground or pavement 48 during operation or transport, allowing the tipper sub-frame 12 and deck 14 to rotate about the pivot shaft 44 located on the wheel assembly main frame 34. This arrangement allows the independent wheel assembly 18 to maintain even and constant contact with the ground 48.

The optional pivoting wheel assembly 18 also allows the main beams 50 of the sub-frame 12 to be spaced farther apart, which is advantageous for a number of reasons. For example, it increases the lateral stability of the tipper 10 both during transport and while in operation. By increasing the lateral stability of the wheel assembly 18 the loads to the rear stabilizers 26 or outriggers is reduced. The wider sub-frame 12 also makes it possible to lower the deck 14 of the tipper 10 so that the top surface of the deck 14 is substantially even with the top surface of the sub-frame 12 beams. As a result, the walkways 28 and handrails 30 may be attached to the sub-frame 12 rather than to the deck 14, thereby reducing the amount of weight that the main hydraulic cylinders 16 are required to lift.

In operation, to prepare the tipper 10 for transport or repositioning, optional stabilizers 22 and 24 may optionally be pivoted up into the raised position, resting on the deck 14 or sub-frame 12 so that the stabilizers 22 and 24 do not extend outward from outer sides of the sub-frame 12. The tipper 10 is connected to a tractor or trailer and is transported, typically over a public road or highway, to a desired site at which the tipper 10 is to be used. At the site, the tipper 10 is removed from the trailer 74 or tractor and the sub-frame 12 is pivoted about the shaft 44 so that a front portion of the sub-frame 12 is lowered toward the ground 48 without raising any of the wheels 38 from the ground 48 (see '695 Patent). At the site, the stabilizers 22 and 24, if present, may also be pivoted to the lowered position, and the bottom pins 64 may be inserted to lock the stabilizers 22 and 24 in the lowered position (see '695 Patent). The adjustable backstop member 54 is retracted or extended as desired to accommodate a trailer 60 of a desired length to be tipped for unloading. At any point during this preparation stage of the tipper 60, the safety hoop 150 may be assembled by operatively connecting the first and second sections 180, 181 to one another at connection points 176A, 176B and by operatively connecting the safety hoop 150 to the trunnion box(es) or another location on the deck 14.

When the tipper is in the position shown in FIG. 1, a tractor backs a trailer 60 to be unloaded up the ramp 32 and onto the deck 14 until the trailer end reaches the cushioning member(s) 101 of the adjustable backstop assembly 20, where the trailer 60 and backstop assembly 20 are cushioned from the force of their collision impact due to the presence of the cushioning member(s) 101. The cushioning member(s) retract upon the impact with the trailer 60, as the biasing force is countered by the trailer 60 force (or in the case of a piston/cylinder assembly, as the piston retracts into the cylinder due to the force of the trailer 60). The trailer 60 is then disconnected from the tractor.

The hydraulic cylinders 16 are actuated to pivotally raise the deck 14 and trailer 60 relative to the sub-frame 12, dumping or unloading dumpable material disposed within the trailer 60. While the deck 14 is being raised relative to the sub-frame 12 and when it is raised to its ultimate position (as well as while the deck 14 is not pivoted relative to the sub-frame 12), the safety hoop 150 prevents the trailer 60 from getting out of position on the deck 14 and from falling from the deck 14. If necessary, the vibrating member 110 may be employed to vibrate the trailer 60 to aid in dislodging the contents of the trailer 60 to be dumped. After the trailer 60 is unloaded, the deck 14 is lowered, the trailer 60 is connected to a tractor, and the tractor removes the trailer 60 from the tipper 10, clearing the way for another trailer to be unloaded. When the trailer 60 is moved from the cushioning member(s) 101, the resilient member(s) return to their original positions (either the biasing force of the spring(s) returns the spring(s) to its/their original lengthened position(s) or the piston/cylinder(s) is/are returned to its/their position with the piston(s) exiting from the cylinder(s) to extend the piston/cylinder assembly length(s)). Optionally, the tipper 10 may be moved to another location, optionally after the safety hoop 150 is disassembled.

Although the above description relates to an embodiment including the safety hoop 150, adjustable backstop 20, and vibrating member 110 in combination with one another, any one or any combination of two of these features may be incorporated into the tipper 10 alone without the other features. Additionally, the cushioning member(s) 101, safety hoop 150, and/or vibrating member 110 may be employed with other types of tippers and backstops known to those skilled in the art. While the foregoing is directed to embodiments of the present invention, other and further embodiments of the invention may be devised without departing from the basic scope thereof, and the scope thereof is determined by the claims that follow.

1. An apparatus comprising:
a first frame;
a deck pivotally secured to a rear portion of the first frame, the deck being sized to support a trailer;
means for pivoting the deck relative to the first frame;
a backstop assembly comprising:
a first backstop member operatively connected to a rear portion of the deck,
a second backstop member slidably secured to the first backstop member, and
means for moving the second backstop member from a retracted position to an extended position over a path that is substantially parallel to an upper surface of the deck; and
one or more cushioning members operatively connected to a trailer-impacting face of the second backstop to lessen the impact of the trailer contacting the backstop assembly.

2. The apparatus of claim 1, wherein the means for moving the second backstop member from the retracted position to the extended position over the path that is substantially parallel to the upper surface of the deck comprises:
first and second guide members affixed to opposite sides of the first backstop member, the first and second guide members defining a path that is substantially parallel to the upper surface of said deck.

3. The apparatus of claim 2, wherein the means for moving the second backstop member from the retracted position to the extended position over the path that is substantially parallel to the upper surface of the deck further comprises an actuator secured to the first and second backstop members.

4. The apparatus of claim 1, wherein the second backstop member is telescopically secured to the first backstop member so that a substantial portion of the second backstop member is disposed within the first backstop member when the second backstop member is disposed in the retracted position.

5. The apparatus of claim 1, wherein the one or more cushioning members are one or more resilient members.

6. The apparatus of claim 5, wherein the one or more resilient members are one or more spring mechanisms.

7. The apparatus of claim 1, wherein the one or more cushioning members are one or more biasing members.

8. The apparatus of claim 1, wherein the one or more cushioning members comprise at least four spaced-apart spring mechanisms.

9. The apparatus of claim 1, further comprising a vibrating mechanism operatively connected to a lower face of the second backstop member for dislodging material from a trailer disposed on the deck.

10. The apparatus of claim 1, further comprising a reinforced safety hoop generally centrally located on the deck around a location at which the trailer is locatable.

11. The apparatus of claim 10, wherein the safety hoop is operatively connected to the deck and generally centered around the means for pivoting the deck relative to the sub-frame.

12. The apparatus of claim 11, wherein the safety hoop comprises at least two beams operatively connected to one another, the beams disposed around the location at which the trailer is locatable, and the beams operatively connected at their lower ends to a trunnion box of the means for pivoting the deck relative to the sub-frame.

13. A method comprising:
providing a trailer tipper comprising:
a first frame,
a deck pivotally secured to a rear portion of the first frame, the deck being sized to support a trailer,
means for pivoting the deck relative to the first frame,
a backstop assembly comprising:
a first backstop member operatively connected to a rear portion of the deck,
a second backstop member secured to the first backstop member, and
one or more cushioning members operatively connected to a trailer-impacting face of the backstop assembly;
transporting the tipper to a site at which the tipper is to be used;
moving the trailer onto the deck until a portion of the trailer impacts the backstop assembly; and
lessening the impact of the trailer contacting the backstop assembly by retraction of the one or more cushioning members.

14. The method of claim 13, wherein the one or more cushioning members are one or more spring mechanisms and the force of impact of the trailer is countered by the biasing force of the one or more spring mechanisms.

15. The method of claim 13, further comprising:
operatively connecting a first assembled section of a safety hoop to a second assembled section of a safety hoop after transporting the tipper to the site;
operatively connecting the safety hoop at or near the means for pivoting the deck relative to the frame; and
after moving the trailer onto the deck through the safety hoop, preventing the trailer from movement from the deck using the safety hoop.

16. The method of claim 15, wherein the safety hoop comprises at least two U-shaped beams operatively connected to one another.

17. The method of claim 13, further comprising:
pivoting the deck relative to the first frame by manipulating the means for pivoting the deck relative to the first frame; and
actuating a vibrating mechanism operatively connected to the backstop assembly to dislodge contents of the trailer from the trailer.

18. A safety hoop for maintaining a trailer on a deck of a trailer tipper, where the trailer tipper comprises the deck pivotable relative to a sub-frame, comprising:
a first generally U-shaped beam member;
a second generally U-shaped beam member; and
one or more reinforcing members operatively connecting the first beam member to the second beam member and bracing the safety hoop structure,
wherein the safety hoop is operatively connected at or near the ends of the U-shaped members to the deck so that when a trailer is located on the deck the trailer is disposed within the U-shaped members.

19. The safety hoop of claim 18, wherein the safety hoop is operatively connected to the deck at or near means for pivoting the deck relative to a sub-frame.

20. The safety hoop of claim 18, wherein the safety hoop is operatively connected to the deck at or near a center of the length of the deck.
